(19) United States
(12) Patent Application Publication
(10) Pub. No.: US 2003/0074569 A1
(43) Pub. Date: Apr. 17, 2003

(54) Data backup method and storage medium for use with content reproduction apparatus

(76) Inventors: Kenichi Yamauchi, Hamamatsu-shi (JP); Katsuaki Tanaka, Hamamatsu-shi (JP)

Correspondence Address: Pillsbury Winthrop LLP, Intellectual Property Group, Suite 2800, 725 South Figueroa Street, Los Angeles, CA, 90017-5406, US

(21) Appl. No.: 10/120,660

(22) Filed: Apr. 11, 2002

(30) Foreign Application Priority Data
Apr. 12, 2001 (JP) 2001-113805

(51) Int. Cl. G06F 11/30

(52) U.S. Cl. 713/189; 705/52

(57) ABSTRACT

The body of content, such as audio or AV content, is provided in encrypted form free of charge. User of a content reproduction apparatus can obtain the content body free at any time, and thus a need to back up the content body can be eliminated. Content key data for decrypting the content is, on the other hand, chargeable and provided for payment, and the user only has to back up this content key data. To prevent the backed-up content key data from being unfairly used by any other apparatus, an apparatus-specific code imparted to the user's content reproduction apparatus is backed up to a backup storage medium along with the content key data, and the backed-up content key data is allowed to be restored from the storage medium only to an apparatus having the same apparatus-specific code as the user's content reproduction apparatus. In this way, the user's content reproduction apparatus can perform an efficient backup of chargeable content.

### BACKGROUND OF THE INVENTION

The present invention relates to an improved data backup method and storage medium which provide for an efficient data backup in content reproduction apparatus that reproduce chargeable (not-free) content, such as audio or AV (Audio Visual) content.

Today, a variety of digitized content of music pieces and motion pictures is being distributed to interested persons in diversified forms. Digital data, such as those of digitized content of music pieces and motion pictures, do not deteriorate in quality, and thus, if copying of the digital data is permitted without limitation, there will be a flood of copies having the same quality as the originals so that the copyrights of the original content can not be appropriately protected any longer. Therefore, for the effective copyright protection, it has been proposed to write the original content into an inner memory, such as a hard disk, of a content reproduction apparatus in such a manner that the written original content can not be unfairly retrieved (copied) from the inner memory.

However, in case the written original content is erased by mistake or the hard disk drive breaks down, content purchased for payment would be lost unless there is a backup copy of the original content. When audio or AV content is to be backed up, it requires a considerable amount of time and a storage medium of a large capacity, because, in general, each item of audio content in the MP3 format has a data size of about 1 MB (megabytes)/min. and each item of AV content in the MPEG2 format has a data size of about 2 GB (gigabytes)/min. Therefore, it has been particularly difficult to construct such a large-capacity storage medium as a security storage medium capable of inhibiting unlimited data copying therefrom.

### SUMMARY OF THE INVENTION

In view of the foregoing, it is an object of the present invention to provide a data backup method and storage medium for use with a content reproduction apparatus which provide for an efficient backup of chargeable (not-free) content.

In order to accomplish the above-mentioned object, the present invention provides a backup method for use with a content reproduction apparatus which reproduces content using a body of encrypted content and content key data for decrypting the encrypted content, and the backup method comprises: a step of imparting an apparatus-specific code to a predetermined content reproduction apparatus; a step of, when content key data is to be backed up from the predetermined content reproduction apparatus to a storage medium, writing the apparatus-specific code into the storage medium along with the content key data; and a step of, when the content key data is to be restored from the storage medium to a particular content reproduction, comparing the apparatus-specific code written in the storage medium along with the content key data and an apparatus-specific code imparted to the particular content reproduction apparatus, and allowing the content key data to be restored from the storage medium to the particular content reproduction apparatus on condition that the compared two apparatus-specific codes match each other.

In the present invention, the body of the encrypted content is provided free of charge, while the content key data is chargeable and provided for payment.

The present invention also provides a backup storage medium for connection to a content reproduction apparatus which reproduces content using a body of encrypted content and content key data for decrypting the encrypted content, and the backup storage medium comprises: a storage area for storing an apparatus-specific code imparted to a predetermined content reproduction apparatus and content key data in corresponding relation to each other; and a control section for receiving an apparatus-specific code from a particular content reproduction apparatus to which the backup storage medium is currently connected, comparing the received apparatus-specific code and the apparatus-specific code stored in the storage area, and allowing the content key data to be output to the particular content reproduction apparatus on condition that the compared two apparatus-specific codes match each other.

FIG. 5 is a block diagram conceptually outlining the basic principles of the present invention. The body of encrypted content, such as audio content, AV (Audio Visual) content or game software, is provided free. As an example of the way to provide the content body, it is conceivable to set up a content distributing site on the Internet so that a user can download the content body free of charge, or to record the content body on a removable backup storage medium, such as a CD-ROM, and provide the storage medium in shops etc. free of charge. Therefore, the user can obtain the content body freely at any time. However, because the content body itself is in encrypted form, the corresponding content key data is required for decrypting the content body. The content key data is chargeable and provided for payment. As an example, the content key data may be purchased by the user on the Internet so that a program of a server can be automatically installed in the content reproduction apparatus of the user.

To prepare for a possible breakdown of the hard disk in such a content reproduction apparatus, it is advisable to back up the content; however, the content body can not be readily backed up due to its great data size. Because the user can obtain the content body free at any time, the content body need not be backed up. Thus, it is only necessary to back up the content key data for decrypting the content; however, in case the backed-up content key data is allowed to be unfairly used by any other apparatus than the user's content reproduction apparatus, it is very likely that the copyright of the content will not be appropriately protected. Therefore, according to the present invention, an apparatus-specific code is imparted to the content reproduction apparatus of the user, and, when the backed-up content key data is to be restored from the backup storage medium to a particular content reproduction apparatus, a comparison is made between the apparatus-specific code written in the backup storage medium along with the content key data and an apparatus-specific code imparted to the particular content reproduction apparatus. Then, the content key data is allowed to be restored from the backup storage medium to the particular content reproduction apparatus on condition that the compared two apparatus-specific codes match each other. Note that the operation for determining the matching between the compared two apparatus-specific codes may be performed by either the user's content reproduction apparatus or the backup storage medium. The apparatus-specific code may be set by inserting a ROM, containing the apparatus-specific code, into the user's content reproduction apparatus.

### BRIEF DESCRIPTION OF THE DRAWINGS

For better understanding of the object and other features of the present invention, its preferred embodiments will be described hereinbelow in greater detail with reference to the accompanying drawings, in which:

FIG. 1 is a block diagram showing an exemplary general setup of an audio reproduction apparatus to which is applied the principles of the present invention;

FIG. 2 is a diagram showing an exemplary inner structure of a memory card with a security function to which is applied the principles of the present invention;

FIGS. 3A and 3B are flow charts showing processes performed by the memory card of FIG. 2;

FIGS. 4A to 4D are flowcharts showing processes performed by the audio content reproduction apparatus of FIG. 1; and

FIG. 5 is a block diagram conceptually outlining the basic principles of the present invention.

### DETAILED DESCRIPTION OF THE PREFERRED EMBODIMENTS

The following will describe embodiments of the present invention, but it should be appreciated that the present invention is not limited to the described embodiments and various modifications of the invention are possible without departing from the basic principles. The scope of the present invention is therefore to be determined solely by the appended claims.

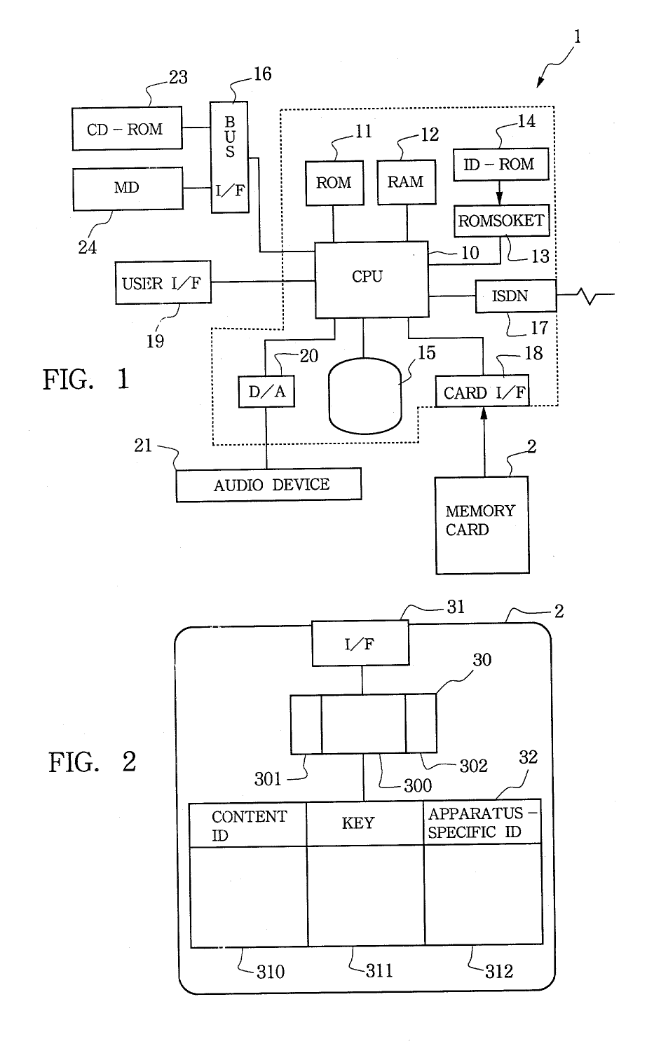

FIG. 1 is a block diagram showing an exemplary general setup of an audio reproduction apparatus to which is applied the basic principles of the present invention. This audio content reproduction apparatus is constructed to store encrypted audio content on a hard disk drive (HDD) 15, read out the recorded audio content in response to operation of a user, decode or decrypt the read-out audio content, and then output the thus-decrypted audio content as audio signals after conversion into analog representation. In general, items of audio content handled by audio content reproduction apparatus are in the MP3 data format and encrypted with corresponding content keys that are content-encrypting and decrypting key data. Thus, in the instant embodiment, the content key corresponding to the audio content is also stored in a predetermined storage area of the hard disk drive (HDD) 15. To protect the copyright of the audio content stored therein, the audio content reproduction apparatus, which is dedicated to audio content reproduction, includes a sealed case accommodating a special function section made up of predetermined components as enclosed by dotted line in FIG. 1, and the content reproduction apparatus permits no access to the interior thereof except via predetermined reproduction/backup software configured to control a user interface 19.

Specifically, the audio content reproduction apparatus includes a CPU (microprocessor) 10 functioning as a controller, to which are connected a ROM 11, a RAM 12, a ROM socket 13, the HDD 15, a bus interface 16, an ISDN board 17, a card interface 18 and the user interface 19. In the ROM 11, there are prestored programs for controlling behavior of the content reproduction apparatus. With the programs prestored in the ROM 11, the content reproduction apparatus can be booted up or activated substantially the moment it is turned on. Version upgrade of the audio content reproduction apparatus is enabled by implementing the ROM 11 by a flash memory and storing the programs in the flash memory as firmware. The RAM 12 includes a storage area for temporarily storing data generated during operation of the content reproduction apparatus.

ID-ROM 14 is inserted in the ROM socket 13. The ID-ROM 14 is a ROM having stored therein an ID code unique to the content reproduction apparatus (hereinafter, called an “apparatus-specific ID”). The apparatus-specific ID is a number uniquely assigned to each one of one or more audio content reproduction apparatus, and thus an identity of the audio content reproduction apparatus can be confirmed by reference to the apparatus-specific ID.

The HDD 15, which has a storage capacity in the range of several gigabytes to tens of gigabytes, stores items of audio content encrypted and compressed in the MP3 format. The HDD 15 also includes a separate storage area for storing content keys for decrypting the corresponding items of the audio content; one unique content key is set for each distinct item of the audio content.

To the bus interface 16 are connected storage-medium reading devices, such as a CD-ROM drive 23 and MD drive 24. The ISDN board 17 is a device for communicating with a central apparatus via a digital line, the Internet or the like. Encrypted audio content is supplied to the audio content reproduction apparatus online or by way of a storage medium such as a CD or MD. In the case where encrypted audio content is supplied via a CD, the CD may be, for example, put in a record shop or electric appliance store to be provided to an interested person free of charge.

On the other hand, the content keys corresponding to various items of audio content can be downloaded online from the central apparatus. Each of such content keys is chargeable (i.e., has to be paid for), and can be purchased for payment using a known online purchase procedure. The content key is downloaded from the central apparatus to the audio content reproduction apparatus through security-retained communication procedures, and then written onto the HDD 15. Steps for writing the content key onto the HDD 15 of the audio content reproduction apparatus are completely encrypted and automatized so that a user can not freely read out the content key.

Further, a semiconductor memory card 2 having a security function (security memory card 2) is inserted in and coupled to the card interface 18. As will be later described in detail, the semiconductor memory card 2 is configured to check the apparatus-specific ID of each reproduction apparatus, to which the memory card 2 is currently connected, at the time of data write or readout to or from the memory card 2, so as to restore the backed-up data only to a reproduction apparatus having the same apparatus-specific ID as the apparatus from which the backed-up data was derived. The audio content reproduction apparatus of FIG. 1 is designed to copy (back up) the content key only to the memory card 2 having such a security function. In this way, the audio content reproduction apparatus of FIG. 1 can not only back up the content key in case of a breakdown of the HDD 15, but also prevent an undesired situation where the backed-up content key is unfairly re-used in another apparatus in such a manner that the copyright of the audio content can not be appropriately protected any longer.

The encrypted audio content is decrypted by the CPU 10 and then passed to a D/A converter 20. The above-mentioned components 11, 12, 13, 14, 15, 17 and 18 and D/A converter 20 constitutes the sealed special function section enclosed by the dotted line in FIG. 1. Within this sealed special function section, the encrypted digital audio content are decrypted and converted into analog audio signals. The audio content, having been thus converted by the D/A converter 20 into analog audio signals, is supplied to an audio device 21 provided with circuits such as an amplifier and tone control. Whereas the tone control (e.g., graphic equalizer) and the like may be implemented by a digital processing section in the audio device 21, the original digital data of the audio content in the instant embodiment are supplied to the audio device 21 or other device after having been converted into analog audio signals.

The user interface 19 includes panel switches, an infrared remote controller, a visual display, etc. so that the user can perform operation not only for instructing reproduction of audio content, but also for reading encrypted audio content into the content reproduction apparatus, purchasing a content key and backing up and restoring the content key.

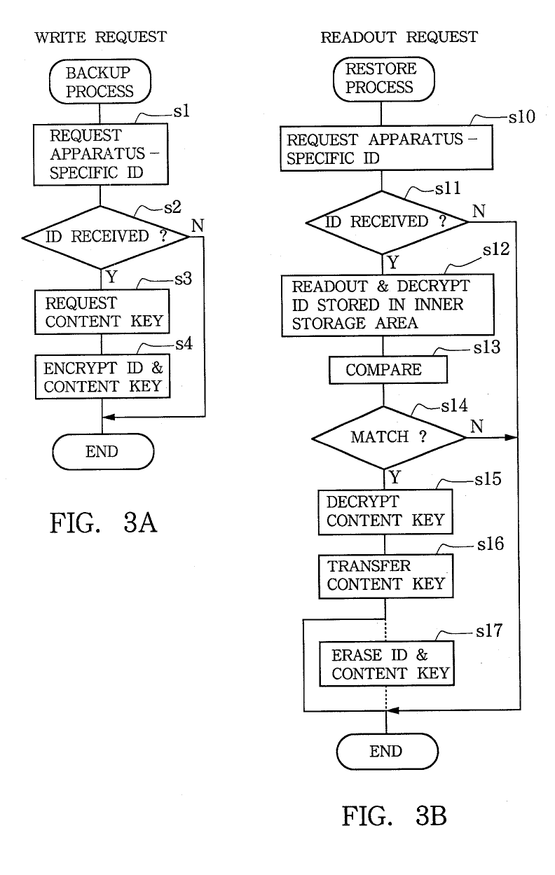

FIG. 2 is a diagram showing an exemplary inner structure of the memory card 2 having the security function. In the illustrated example, this memory card 2 may be an “SD card” (trademark) or “MagicGate memory stick” (trademark), which is constructed in such a manner that stored contents can not be freely read out therefrom unless predetermined conditions are met. Within the memory card 2, there are provided a controller 30, an interface 31 and a flash memory 32. The controller 30, which controls data write and readout to and from the memory card 2, includes a CPU 300, a program memory 301 and an encrypting key memory 302. The program memory 301 and encrypting key memory 302 are implemented by a flash memory or SRAM (Static RAM), and the program memory 301 has prestored therein programs for controlling data write and readout to and from the memory card 2. Processes performed by these control programs will be described later in relation to FIG. 3. The encrypting key memory 302 stores an encrypting key for encrypting data to be written onto the card 2. As shown, the flash memory 32 has storage areas allocated for backing up each content key stored in the audio content reproduction apparatus to which the memory card 2 is connected. Specifically, the storage areas include a content key storage area 311, a content ID storage area 310 for storing the content ID identifying the audio content to which the content key in question corresponds, and an apparatus-specific ID storage area 312 for storing the apparatus-specific ID of the audio content reproduction apparatus from which the content key was backed up. Note that when all content keys stored in the audio content reproduction apparatus are to be backed up collectively, all of the content keys are associated with the single or same apparatus-specific ID imparted to the content reproduction apparatus.

The content key backup may be performed separately for each content key, or all content keys stored in the audio content reproduction apparatus may be backed up collectively as noted above. In another alternative, content keys stored in a plurality of predetermined audio content reproduction apparatus may be backed up to a single or same memory card 2.

FIGS. 3A and 3B are flow charts showing processes performed by the memory card 2. These process are performed when the memory card 2 is set in or operatively connected to the audio content reproduction apparatus. More specifically, the backup process flowcharted in FIG. 3A is carried out, in response to a write request from the audio content reproduction apparatus, for backing up a content key stored in the HDD 15 of the content reproduction apparatus. Namely, once such a write request is received from the audio content reproduction apparatus, the memory card 2 in turn requests the apparatus-specific ID from the content reproduction apparatus at step s1, and then receives the apparatus-specific ID from the content reproduction apparatus, at step s2. In case the apparatus-specific ID is not received from the content reproduction apparatus even after a predetermined time has elapsed, the memory card 2 judges that a secure backup, capable of reliably preventing unfair data readout by any other apparatus, is impossible in this case, and then terminates the instant process. If, on the other hand, the apparatus-specific ID is received from the content reproduction apparatus within the predetermined time period, then the memory card 2 requests a content key from the content reproduction apparatus, at step s3. At next step s4, the memory card 2 encrypts the received apparatus-specific ID and content key (including the content ID) and then stores the thus-encrypted ID and content key.

At step s4, all contents stored in the audio content reproduction apparatus may be collectively received and stored in the memory card 2, or only a user-designated content key may be stored in the memory card 2; alternatively, every content having not yet been backed up to the memory card 2 may be automatically designated and stored separately in the memory card 2.

The restore process flowcharted in FIG. 3B is carried out, in response to a readout request from the audio content reproduction apparatus, for restoring a content key to the content reproduction apparatus. Namely, once a content key readout request is received from the audio content reproduction apparatus, the memory card 2 requests the content reproduction apparatus to send back the apparatus-specific ID, at step 10. If the apparatus-specific ID is sent, the memory card 2 receives the ID, but if not, the memory card 2 terminates the restore process after disabling data readout therefrom. In the case where the apparatus-specific ID is received from the audio content reproduction apparatus, the memory card 2 reads out the apparatus-specific ID stored in its inner storage area 312 of the card 2, at step s12. Then, the memory card 2, at step s13, compares the apparatus-specific ID received from the audio content reproduction apparatus and the apparatus-specific ID read out from the storage area 312. If the two apparatus-specific IDs match each other as determined at step s14, it means that the restore request has been given from the apparatus from which the apparatus-specific IDs was backed up earlier, and thus the memory card 2 reads out the content key from its inner storage area 311 and decrypts the thus read-out content key, at step s15. Then, the memory card 2 transfers the decrypted content key to the audio content reproduction apparatus at step s16. If, on the other hand, the apparatus-specific ID received from the audio content reproduction apparatus and the apparatus-specific ID read out from the storage area 312 do not match each other as determined at step s14, it means that the restore request has been given from an apparatus other than the apparatus from which the apparatus-specific IDs was backed up earlier, and thus the memory card 2 terminates the restore process after disabling data readout therefrom.

Note that after transferring the content key to the audio content reproduction apparatus, the memory card 2 may either erase (remove) the content key and apparatus-specific ID from the respective inner storage areas or leave the content key and apparatus-specific ID stored as backup data.

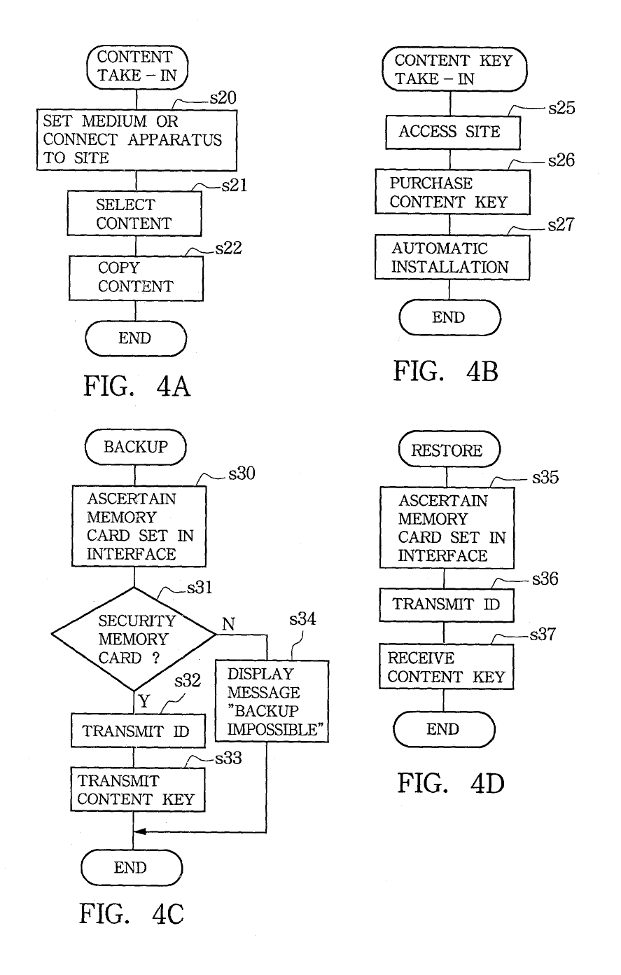

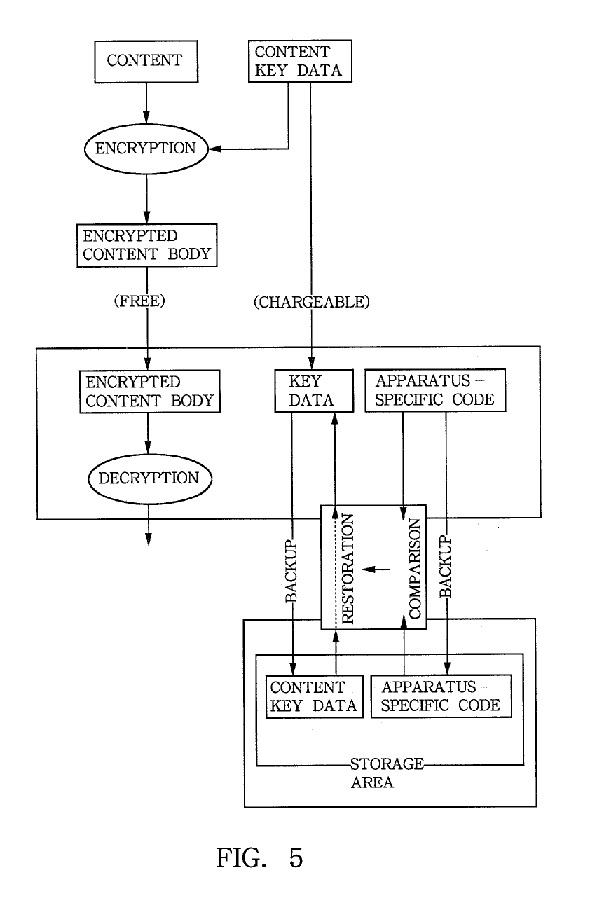

FIGS. 4A to 4D are flowcharts showing processes performed by the audio content reproduction apparatus. The content take-in process flowcharted in FIG. 4A is directed to writing audio content onto the HDD 15 of the audio content reproduction apparatus. At first step s20, a CD-ROM or MD provided free of charge is set in the corresponding drive 23 or 24, or the content reproduction apparatus is connected via the Internet to a site distributing audio content. The user selects a desired item of the audio content from the thus-set storage medium, i.e. CD-ROM or MD, or from the Internet site, at step s21. Then, at step s22, the content reproduction apparatus copies the selected audio content from the storage medium or Internet site to the HDD 15.

The content key take-in process flowcharted in FIG. 4B is directed to writing a content key onto the HDD 15 of the audio content reproduction apparatus. Here, the user accesses a site selling content keys on the Internet at step s25, and then purchases the content key of a desired music piece (audio content) at step s26. At next step s27, a predetermined program stored in the selling site is automatically installed in the audio content reproduction apparatus. The user pays for the purchased content key, for example, by a credit card. Because the purchased content key is sent via the Internet to the content reproduction apparatus through secret procedures, the content reproduction apparatus writes the purchased content key to the HDD 15. Although data management, such as for erasing the data from the HDD 15, is permitted, the data can not be read out from the HDD 15 in any way, except in response to a proper instruction for backing up data or reproducing audio content.

The backup process performed by the audio content reproduction apparatus is flowcharted in FIG. 4C. When a content key is to be backed up, it is first ascertained at step s30 whether a memory card is currently set in the card interface 18. If a memory card is currently set in the card interface 18, it is further determined at step s31 whether the inserted card is a security memory card 2 as described above in relation to FIGS. 2 and 3. If no card is currently set in the card interface 18 or the set card is not the security memory card 2 as determined at step s30 or s31, the content reproduction apparatus indicates on the visual display a message “Backup Impossible” at step s34, and then terminates the instant process. If the set card is the security memory card 2, the content reproduction apparatus sends, at step s32, the apparatus-specific ID to identify the apparatus from which to back up data. At next step s33, the content reproduction apparatus sends the memory card 2 the content key along with the content ID, so as to back up the key and ID to the memory card 2.

The restore process performed by the audio content reproduction apparatus is flowcharted in FIG. 4D. This restore process is carried out when the HDD 15 has broken down and has been replaced with another one, when a desired content key or all content keys stored on the HDD 15 have been erased by mistake. After startup of this restore process, a determination is made at step s35 as to whether a memory card is currently set in the card interface 18. If answered in the affirmative at step s35, the audio content reproduction apparatus transmits the apparatus-specific ID to the set memory card at step s36. In the case where the currently-set memory card is the security memory card 2 as shown in FIGS. 2 and 3, the security memory card 2 checks the apparatus-specific ID and then automatically sends the content key, so that the content reproduction apparatus receives the content key from the memory card 2 and restores the received content key to a predetermined storage area of the HDD 15.

Whereas the embodiment has been described above in relation to an audio content reproduction apparatus, content handled by the present invention may be other than audio content, such as video content or game software.

In summary, the present invention is characterized by backing up only key data for decrypting desired content instead of backing up the main body of the encrypted content. With such an arrangement, the present invention can facilitate the data backup and subsequent restoring operations. Further, the present invention is characterized in that the apparatus-specific code of the content reproduction apparatus is used to reliably allow the backed-up content key data to be restored only to the same reproduction apparatus. This arrangement can effectively prevent the backed-up content key data from being unfairly used by any other apparatus so that the copyright of the content can not be appropriately protected any longer.

What is claimed is:

1. A backup method for use with a content reproduction apparatus which reproduces content using a body of encrypted content and content key data for decrypting the encrypted content, said backup method comprising:
a step of imparting an apparatus-specific code to a predetermined content reproduction apparatus;
a step of, when content key data is to be backed up from the predetermined content reproduction apparatus to a storage medium, writing the apparatus-specific code into the storage medium along with the content key data; and
a step of, when the content key data is to be restored from the storage medium, comparing the apparatus-specific code written in the storage medium along with the content key data and an apparatus-specific code imparted to a particular reproduction apparatus, and allowing the content key data to be restored from the storage medium to the particular content reproduction apparatus on condition that the compared apparatus-specific codes match each other.

2. A backup method as claimed in claim 1 wherein the body of the encrypted content is provided free of charge while the content key data is chargeable and provided out for payment.

3. A backup storage medium for connection to a content reproduction apparatus which reproduces content using a body of encrypted content and content key data for decrypting the encrypted content, said backup storage medium comprising:
a storage area for storing an apparatus-specific code imparted to a predetermined content reproduction apparatus and content key data in corresponding relation to each other; and
control means for receiving an apparatus-specific code from a particular content reproduction apparatus to which said backup storage medium is currently connected, comparing the received apparatus-specific code and the apparatus-specific code stored in said storage area, and allowing the content key data to be output to the particular content reproduction apparatus on condition that the compared apparatus-specific codes match each other.
